(19) United States
(12) Patent Application Publication
(10) Pub. No.: US 2025/0384369 A1
(43) Pub. Date: Dec. 18, 2025

(54) BILL OF MATERIALS RECOMMENDATION SYSTEM

(71) Applicant: Schneider Electric USA, Inc., Boston, MA (US)

(72) Inventors: Mahmudul Hasan BHUIYAN, Bengaluru (IN); Kiran Kumar YADALAM, Bengaluru (IN); Bhawani NAYAK, Bengaluru (IN); Lokanath PANDA, Bengaluru (IN); Akhil NARAYANAN, Bengaluru (IN); Navkirat SINGH, Bengaluru (IN); Kranthi Kumar MUTYALAPALLI, Bengaluru (IN); Dipanjan BISWAS, Bengaluru (IN)

(21) Appl. No.: 19/237,452

(22) Filed: Jun. 13, 2025

(30) Foreign Application Priority Data
Jun. 14, 2024 (IN) 202411046107

(51) Int. Cl. G06Q 10/0631; G06Q 10/0875; G06Q 30/0601

(52) U.S. Cl. CPC G06Q 10/06315; G06Q 10/0875; G06Q 30/0621

(57) ABSTRACT

A system for generating a bill of materials comprising one or more product recommendations aligned with customer requirements, comprises a bill of materials processing device. The bill of materials processing device is configured to execute an AI-based recommendation engine. The recommendation engine is configured to receive customer data from one or more user inputs, retrieve product data from a product data source, and retrieve transaction data from a transaction data source. The recommendation engine includes a pre-processing module, training module, and inference module. The pre-processing module executes one or more pre-processing techniques to translate the data into a program-compatible format. The training module executes training and inference processes to generate the bill of materials. The training processes put the data in better condition for the inference module. The inference module uses two or more product recommendation processes to evaluate the data and to generate the BOM in a machine-readable format.

### CROSS-REFERENCE TO RELATED APPLICATION

This application claims the benefit of Indian Provisional Application No. 202411046107, filed Jun. 14, 2024, the entire disclosure of which is incorporated herein by reference.

### FIELD

This disclosure relates to systems and methods for generating a bill of materials that includes product recommendations aligned with customer requirements.

### BACKGROUND

Product recommendation systems are used by businesses to create product recommendations for customers. Current recommendation systems are mostly generalized and suggest different types of products than what is actually needed.

### SUMMARY

Aspects of the present disclosure provide a system for automatically creating a bill of materials comprising relevant products to recommend to a customer.

In one aspect, a system comprises a bill of materials (BOM) processing device. The BOM processing device is in operable communication with a product data source and a transaction data source. The product data source stores product data associated with a company's product portfolio. The transaction data source stores transaction data associated with the company's transactions. A memory device is in operable communication with the BOM processing device and stores processor-executable instructions defining a recommendation engine that, when executed, configures the BOM processing device for receiving, via a user input, customer data representative of customer information and customer product requirements. Product data is retrieved from the product data source based on the customer data. Transaction data is retrieved from the transaction data source based on the customer data. At least one of the customer data, product data, or transaction data is evaluated to determine two or more product recommendation processes for determining one or more products for generating a bill of materials that aligns with the customer product requirements. The product recommendation processes are executed based at least on the customer data, product data, or transaction data to generate the bill of materials in a machine-readable format.

In another aspect, a system comprises a bill of materials (BOM) processing device. The BOM processing device is in operable communication with a product data source and a transaction data source. The product data source stores product data associated with a company's product portfolio. The transaction data source stores transaction data associated with the company's transactions. A memory device is in operable communication with the BOM processing device and stores processor-executable instructions defining a recommendation engine that, when executed, configures the BOM processing device for receiving, via a user input, customer data representative of customer information and customer product requirements. Product data is retrieved from the product data source based on the customer data. Transaction data is retrieved from the transaction data source based on the customer data. One or more training processes are executed based at least on the customer data, product data, or transaction data. Said training processes comprise at least one of a vocabulary creation process, a popularity score generation process, an embeddings generation process, or an associated itemset generation process.

In another aspect, a computer-implemented method comprises receiving, via a user input, customer data representative of customer information and customer product requirements. Product data associated with a company's product portfolio is retrieved from a product data source based on the customer data. Transaction data associated with the company's transactions is retrieved from a transaction data source based on the customer data. The customer data, product data, and transaction data are processed to generate a machine-readable bill of materials. The machine-readable bill of materials comprises one or more product recommendations that align with customer product requirements. A model error is calculated. The model error is compensated for. The method is re-executed to generate a new machine-readable bill of materials that compensates for the model error.

Other aspects, advantages, and features will be in part apparent and in part pointed out hereinafter.

### BRIEF DESCRIPTION OF THE DRAWINGS

FIG. 1 is a flow chart illustrating a conventional quotation process;

FIG. 2 is flow chart illustrating a quotation process of the present disclosure, according to an embodiment;

FIG. 3 is a block diagram of a system for generating a BOM, according to an embodiment;

FIG. 4 is a schematic illustration of a process of a training module, according to an embodiment;

FIG. 5 is a schematic illustration illustrating community-based filtering, according to an embodiment;

FIG. 6 is a schematic illustration illustrating content-based filtering, according to an embodiment;

FIG. 7 is a schematic illustration illustrating collaborative-based filtering, according to an embodiment;

FIG. 8 is a schematic illustration illustrating knowledge-based filtering, according to an embodiment;

FIG. 9 is a block diagram of a system for generating a BOM, according to an embodiment;

FIG. 10 is a flowchart illustrating processes of a recommendation engine, according to an embodiment;

FIG. 11 is a schematic illustration of a process of an inference module, according to an embodiment;

FIG. 12 is a flowchart illustrating a method for generating a BOM, according to an embodiment;

FIG. 13 is an image of an example of measuring a performance of a system for generating a bill of materials and retraining the system, according to an embodiment;

FIG. 14 is a schematic block diagram illustrating a data and training pipeline, according to an embodiment;

FIG. 15 is a schematic block diagram illustrating a machine training and inference architecture for generating a smart BOM, according to an embodiment;

FIG. 16 is a schematic block diagram illustrating an example inference architecture for generating a smart BOM, according to an embodiment;

FIG. 17 is a flowchart illustrating a process for generating a smart BOM, according to an embodiment;

FIG. 18 is a block diagram illustrating a system for generating a smart BOM, according to an embodiment;

FIG. 19 is a block diagram illustrating data and data relationships according to an embodiment;

FIG. 20 is a schematic block diagram illustrating a data and training pipeline, according to an embodiment;

FIG. 21 is a schematic block diagram illustrating an inference pipeline, according to an embodiment;

Corresponding reference characters indicate corresponding parts throughout the drawings.

### DETAILED DESCRIPTION

Recommending relevant products to customers to meet their needs can be a daunting task for companies, especially when the companies have large product portfolios to choose from. Conventionally a company's sales team is tasked with highly manual and offline quotation processes for recommending products to customers. However, time and resources involved in product recommendation may be reduced by automating certain aspects of the quotation process. As will be described in further detail below, this disclosure pertains to computer-implemented systems and methods for automatically generating a bill of materials (BOM) used in company quotation processes. The present disclosure leverages multiple different product recommendation processes to provide a customer-specific BOM that includes personalized and relevant product recommendations for customers. Accordingly, the present disclosure also benefits the customer by improving the efficiency and accuracy of procurement processes.

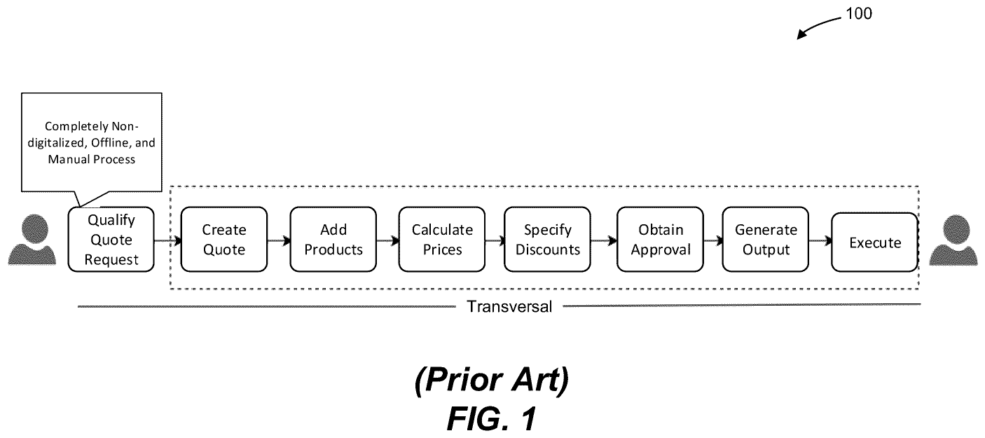

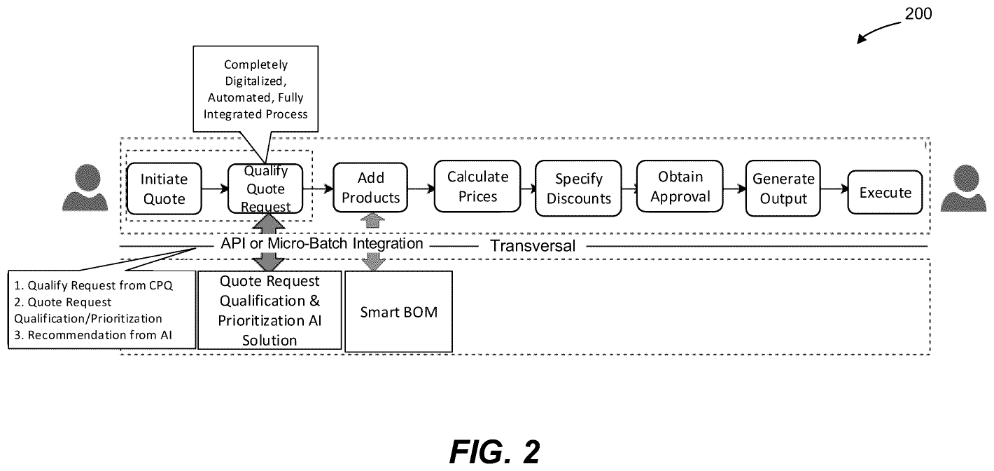

Referring now to FIG. 1, a flowchart illustrating an example of a conventional quotation process is generally indicated at reference number 100. At an initial step of the conventional quotation process, a quote request is qualified. With conventional quotation processes, this is a completely non-digitalized, offline, and manual process. The same may be true with the third step of adding products, or conventional automated processes may be used. Such processes are often limited and provide irrelevant results. On the contrary, FIG. 2 comprises a flowchart illustrating an example of a quotation process 200 in accordance with the present disclosure. With the quotation process 200, the step of qualifying a quote request is a completely digitalized, automated, and fully integrated process. Furthermore, the step of adding products to the quotation, is automated with the system of the present disclosure that provides a smart BOM that includes product recommendations that align with customer product requirements.

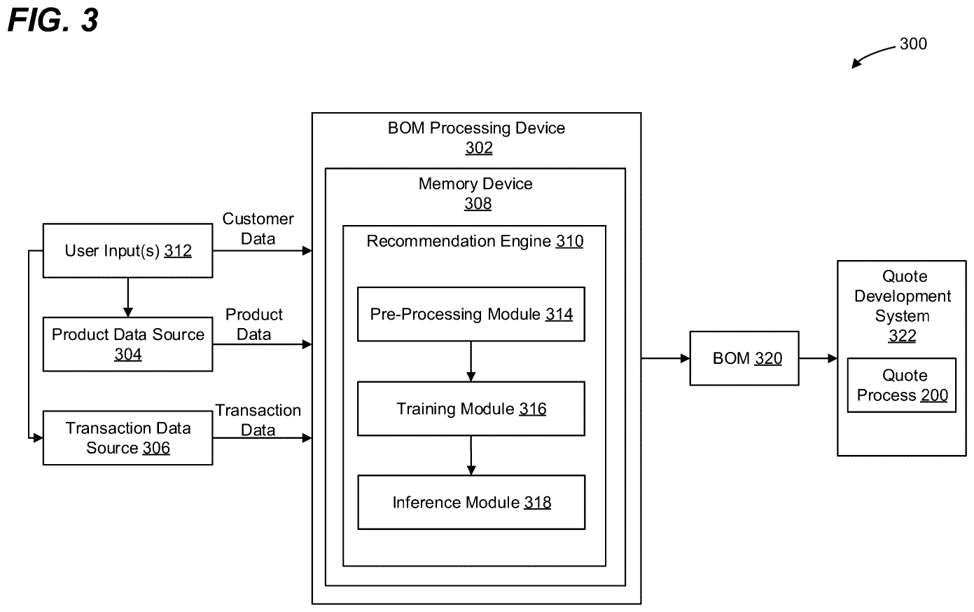

Referring now to FIG. 3, an exemplary embodiment of a system for generating a personalized BOM is generally indicated at reference number 300. Broadly, the system 300 comprises a BOM processing device 302 in operable communication with a product data source 304 storing product data associated with a company's product portfolio, a transaction data source 306 storing transaction data associated with a company's transactions, and a memory device 308 storing processor-executable instructions defining a recommendation engine 310. In general, the BOM processing device 302 is configured to execute the recommendation engine 310 to receive via a user input 312, customer data representative of customer information and customer product requirements, retrieve product data from the product data source 304 based on the customer data, retrieve transaction data from the transaction data source 306 based on the customer data, and process the input data to generate a BOM 320 that aligns with the customer product requirements specified in the customer data. Furthermore, the BOM processing device 302 is configured to transmit the BOM 320 in a machine-readable format to a quote development system 322 for automatically executing the quotation process 200 therewith. Individual components and alternative embodiments of the system 300 will now be described before turning to an exemplary computer-implemented method that the system may execute for generating a customer-specific BOM that includes personalized and relevant product recommendations for customers.

One or more user inputs 312 are used for acquiring customer data representative of customer information and customer product requirements for generating the BOM 320. For example, the customer data may indicate at least one of a name of the customer, an account number for the customer, customer product requirements, whether the customer is a new or returning customer, or opportunity data for the customer. In this context, opportunity data includes data pertaining to a customer's past purchasing behavior or preferences.

The product data source 304 is configured to store product data associated with a company's product portfolio. For example, the product data may include product names and descriptions for products in a company's product portfolio.

The transaction data source 306 is configured to store transaction data associated with a company's transactions. For example, the transaction data may include historic quotation data that indicates a quote number, a quote description, and a customer in which the quote was for.

The following data set provides an example of input data used to generate the BOM 320. The data set contains information on historical quotations, opportunity details, and product details.
1. Quote_number: This unique identifier serves as the key to access all the quotation information.
2. Opportunity_name: This includes a brief description of the opportunity. (TEXT)
3. Quotation_description: This includes a detailed description of the quotation. (TEXT)
4. Account_quote_to_name: This includes the name of the customer account to which the quote is associated. (TEXT)
5. Material_ID: Unique identifier for each product in the dataset.

The BOM processing device 302 includes a processor, a memory, user inputs 312, a display, and other related elements. The BOM processing device 302 may also include circuit boards and/or other electronic components such as a transceiver or external connection for communicating with other components of the system 300. For example, the BOM processing device 302 includes components such as wireless transceivers and/or wired connectors that connect the BOM processing device to the product data source 304, the transactions data source 306, and other components of the quote development system 322. In general, the BOM processing device is configured to execute the recommendation engine 310 to generate the BOM 320 based on customer data obtained from one or more user inputs 312, product data stored in the product data source 304, and transaction data stored in the transaction data source 306. Accordingly, the memory device 308 stores processor-executable instructions defining the recommendation engine 310, and a processor of the processing device 302 is configured to execute the instructions in order to generate the BOM 320.

The recommendation engine 310, when executed configures the BOM processing device 302 for receiving/retrieving the customer data, product data, and transaction data. The recommendation engine 310 comprises a plurality of software modules that perform various automation functions related to the automation of a personalized BOM generation process. The illustrated recommendation engine 310 comprises a pre-processing module 314. The pre-processing module 314 is configured to receive/retrieve and pre-process the customer data, product data, and transaction data into a program-compatible format, and transmit the pre-processed program-compatible data to other modules of the recommendation engine 310.

In one example, pre-processing the customer data, product data, and transaction data comprises at least one of a named entity recognition (NER) tagging and removal process, a text case conversion process, an unwanted symbol removal process, a white space normalization process, or a stop word removal process. For example, the NER tagging and removal process is executed to identify data as Named-Entities that fall under Organization (ORG) and Geographical Location (GPE) categories. In an exemplary embodiment, the pre-processing module 314 is configured to use Spacy, the Python library to perform NER tagging and remove any words that were identified as ORG or GPE. This enables a more relevant text corpus for creating word embeddings. Removing irrelevant words makes it easier for similarities between quotations to be identified in later processes. The pre-processing module 314 is configured to filter out words that don't impact similarity calculations executed by the recommendation engine 310 to create a customized stop words list. The pre-processing module 314 may be configured to add relevant words to an existing list of stop words from the Natural Language Toolkit (NLTK) to fine tune the stop words list and improve the performance of the recommendation engine 310. In an exemplary embodiment, the pre-processing module 314 is also configured to use the cleantext.sklearn library to preprocess text. For example, the data preprocessing engine uses the cleantext.sklearn library to convert text to lowercase, remove unwanted symbols, normalize white spaces, remove stop words, and apply the NER removal function.

The recommendation engine 310 further comprises a training module 316. The training module 316 is configured to receive the pre-processed program-compatible data from the pre-processing module 314. Furthermore, the training module 316 is configured to execute one or more training processes based at least on the pre-processed customer data, product data, and transaction data. In one example, the training processes comprise at least one of a vocabulary creation process, a popularity score generation process, an embeddings generation process, or an associated itemset generation process.

In the vocabulary creation process, the training module 316 is configured to split text data into individual words and create a list comprising all of the individual words. Furthermore, the training module 316 is configured to remove duplicate words in the list to create a vocabulary comprising unique individual words. This vocabulary is used to determine if any of the data (e.g., a new quotation description, opportunity name, etc.) is new or if the input has historical existence. This allows an inference module 318 of the recommendation engine 310 to determine which product recommendation processes to use to generate the customer-specific BOM 320, as will be explained in greater detail below.

As will be described in further detail below, the inference module 318 of the recommendation engine 310 is configured to employ a popularity-based filtering product recommendation process. Popularity-based filtering is particularly useful when certain data such as customer data and/or transaction data is not available, or limited. To prepare for this process, the training module 316 is configured to execute the popularity score generation process to calculate a popularity score for each product in the product data. An exemplary approach taken by the training module 316 for calculating the popularity scores will now be described.

Initially, a column “x” is created that represents the frequency of each product in the dataset. The popularity score is then calculated using the following formula:

$$Popularity Score = 5 * ( ( x - min ( x ) ) / ( max ( x ) - min ( x ) ) )$$

Here, “x” represents the continuous variable column of interest in the data frame. The resulting score is normalized between 0 and 5, where higher scores indicate higher popularity. This calculation enables the ranking of quotes (from the transaction data) based on their popularity, which can be useful in recommending quotes to customers or identifying the most successful quotes.

In the embeddings generation process, the training module 316 configured to create one or more embeddings for each text instance of the data. Embeddings are a way to represent textual data as a set of continuous numerical values. These embeddings can then be used to calculate the similarity between different textual data. An exemplary approach taken by the training module 316 for creating embeddings will now be described.

To create embeddings for the text columns, the opportunity_name and quote_description columns are concatenated after preprocessing them using techniques such as tokenization, stop word removal, and stemming. The resulting pre-processed text is then used to create a dictionary of unique words using the Gensim package's corpora.Dictionary method.

Next, a corpus is created from the dictionary using the Gensim package's doc2bow method. This corpus is a collection of sparse vectors, where each vector represents a single text instance, and the values in the vector represent the frequency of each word in the dictionary.

To create the embeddings, a Latent Semantic Indexing (LSI) model is used. LSI is a technique that reduces the dimensionality of the corpus while retaining its most important information. It does this by identifying the underlying topics in the corpus and representing each document as a linear combination of these topics.

The LSI model is created using the Gensim package's LsiModel method and pass in the corpus and the dictionary. The number of topics is specified as 1500 (also referred to the dimensions of embeddings). This number can be adjusted depending on the size and complexity of the corpus. Choosing the optimal number of topics is crucial in topic modeling, as increasing or decreasing the number can have significant effects on the interpretability and granularity of the representation. To determine the optimal number of topics, the CoherenceModel class is used from the Gensim library. This class computes the coherence score of a topic model, which is a measure of how interpretable and meaningful the topics generated by the model are. The coherence score is computed using different coherence measures, such as UMass, C_V, C_PMI, and C_NPMI, each with its own formula. By analyzing the coherence score for different numbers of topics, an optimal number of topics is found for the model. It's important to note that finding the optimal number of topics is not always straightforward, as the balance between granularity and noise can vary depending on the specific dataset and use case.

In one example, after experimenting with different numbers of topics, it was found that 1500 topics provided a good balance between granularity and interpretability. This enables a more detailed and meaningful representation of the text data.

Finally, an index is created from the LSI model and the corpus using the Genism package's Matrix Similarity method. This index can be used to calculate the similarity between a query string embedding and all the embeddings created in the training phase. By creating embeddings for the text columns using LSI, underlying topics are captured in the text data and represent each instance as a set of continuous numerical values. These embeddings can then be used to calculate the similarity between different instances and make recommendations based on user/customer preferences.

Associated itemsets refer to sets of products that are frequently purchased together by customers. By analyzing customer purchase history, companies can identify these patterns and use them to increase cross-selling opportunities.

For popular products, companies can use associated itemsets to suggest complementary or related products to customers during the purchasing process. For example, if a customer is buying a new smartphone, the company retailer could suggest a protective case, screen protector, or wireless earbuds that are frequently purchased with that specific model of smartphone. Retailers can also use associated itemsets to create targeted promotions and discounts to incentivize customers to purchase complementary products. By offering discounts on a bundle of products that are frequently purchased together, companies can increase the average order value and improve customer satisfaction. Overall, utilizing associated itemsets is a powerful tool for retailers looking to increase cross-selling opportunities, and improve the customer shopping experience.

In one example of the associated itemset generation process, the training module 316 uses associated itemsets to suggest complementary or related components to manufacturers during the product design and manufacturing process. For example, if a manufacturer is designing a new smartphone, the training module 316 analyzes transaction and product data to identify commonly used components and suggest related components that are frequently used together. This could include components such as batteries, screens, processors, or cameras that are often used together in smartphones. By leveraging associated itemsets in BOM recommendations, manufacturers can optimize their component selection and reduce the risk of design errors. Additionally, manufacturers can use this information to negotiate better pricing with suppliers by leveraging their buying power for frequently purchased components. Overall, associated itemsets in BOM recommendations offer manufacturers a powerful tool for optimizing their component selection, reducing costs, and improving product quality.

In one example, the training module 316 is configured to execute the training processes using at least one of an FP Growth Tree algorithm or an Apriority algorithm. However, it will be apparent to a person of ordinary skill, that other algorithms may be used without departing from the scope of the present disclosure. FP-growth and Apriori are two popular algorithms used in data mining for finding frequent itemsets in large datasets. Apriori is an algorithm that works by generating frequent itemsets by iterating through the dataset multiple times. Apriori starts by finding all individual items that meet the minimum support threshold and then proceeds to generate frequent itemsets of increasing size. Apriori is an iterative process that requires multiple passes through the dataset, making it computationally expensive for large datasets. FP-growth, on the other hand, is a more efficient algorithm that uses a different approach. It first builds a tree structure called an FP-tree from the dataset and then extracts frequent itemsets directly from the tree. The FP-tree structure allows for efficient counting and manipulation of frequent itemsets, making it faster and more memory-efficient than Apriori, especially for large datasets. In terms of performance, FP-growth tends to outperform Apriori in terms of both speed and memory efficiency. However, Apriori is more widely used and understood, making it a good choice for smaller datasets or when a simple algorithm is preferred.

Overall, the choice between FP-growth and Apriori depends on the specific needs and constraints of the problem at hand. If speed and memory efficiency are a priority, FP-growth is likely the better choice. However, if simplicity and ease of use are more important, Apriori may be the better option. For example, for a large country like India, FP growth is the suitable option whereas for a small country like Singapore, it is better to use Apriori. The training module 316 is configured to use either of the algorithms.

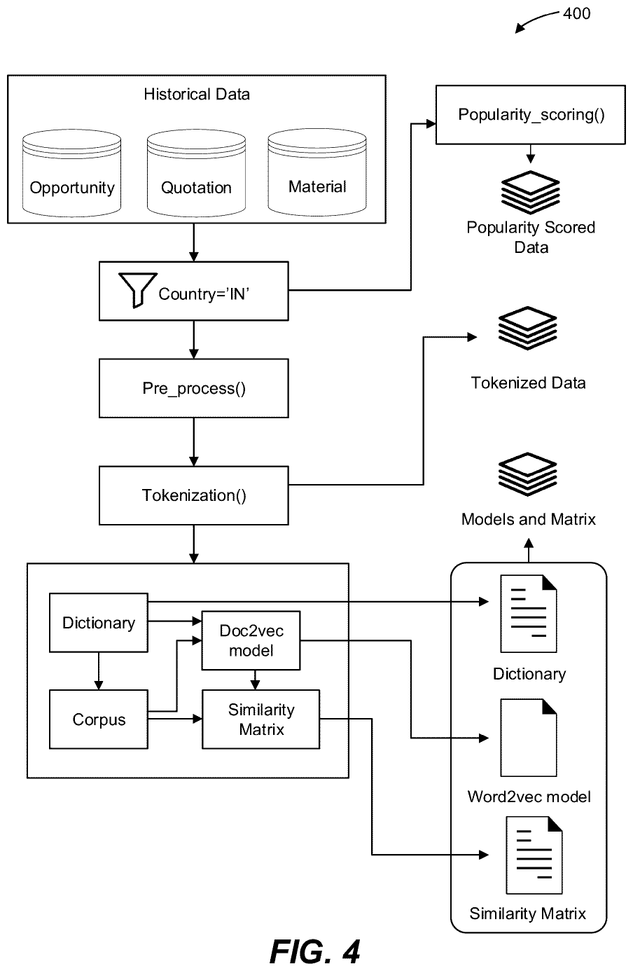

Referring now to FIG. 4 an exemplary implementation of the pre-processing module 314 and training module 316 is generally indicated at reference number 400. In this implementation, opportunity data, quotation data, and material data (product data) are retrieved, filtered, and pre-processed. Furthermore, popularity-based filtering is executed to determine popularity scores for the data. The data is tokenized and a dictionary, Word2vec model, and similarity matrix is generated based thereon.

The recommendation engine 310 further comprises the inference module 318. The inference module 318 is configured to receive the pre-processed and trained data from the training module 316. The inference module 318 is also configured to receive only the pre-processed data from the pre-processing module 314. In general, the inference module 318 is configured to evaluate at least one of the customer data, product data, or transaction data to determine two or more product recommendation processes for determining one or more products for generating the BOM 320 that aligns with the customer product requirements specified by the customer data. Moreover, the inference module is configured to execute the product recommendation processes based at least on the customer data, product data, or transaction data to generate the bill of materials in a machine-readable format. Exemplary product recommendation processes will now be described.

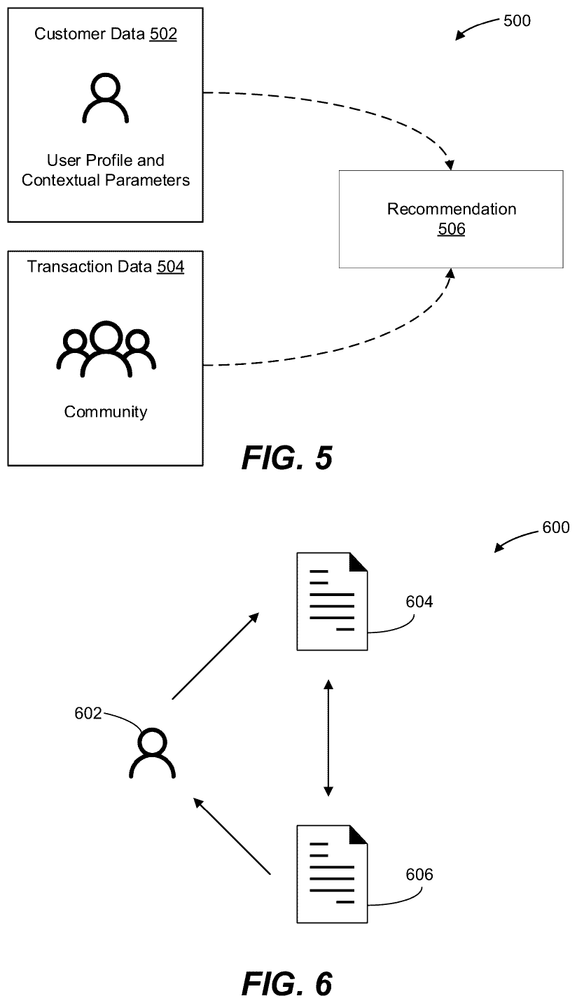

One example of a product recommendation process in accordance with the present disclosure includes community-based filtering. In the exemplary embodiment of FIG. 5, community-based filtering 500 utilizes customer data 502 comprising a user profile for the customer and contextual parameters, and transaction data 504 regarding a community in which the customer is associated with, to make a product recommendation 506. In general, community-based filtering 500 identifies a community in which a customer belongs, and recommends product(s) that others in the community are interested in, to the customer. Similarly, community-based filtering identifies a community in which a product of interest belongs, and recommends other product(s) in the product of interest's community to the customer. Furthermore, community-based filtering leverages the behavior and preferences of similar users/customers to recommend products that are likely to meet their needs. For example, if the customer is a young female, employing community-based filtering could involve recommending content that other young females enjoyed.

Another example of a product recommendation process in accordance with the present disclosure includes popularity-based filtering. Popularity-based filtering is an approach in which the most popular products in each category or segment are recommended to a customer/user. Popularity-based product recommendation uses data on the most popular products to recommend items that are likely to be well-received by users/customers. This technique relies on the fact that products that are frequently purchased or viewed by other customers are likely to be of high quality or meet the needs of most customers in that category. Popularity-based filtering can be useful in situations where a customer has not provided any explicit preference data, or where the available data is limited. For example, if a user and/or customer is browsing a particular category on an e-commerce site but hasn't provided any specific preferences, the site may recommend the most popular products in that category to the user/customer. This can be a useful starting point for the user/customer to explore and narrow down options.

Referring now to FIG. 6, another example of a product recommendation process in accordance with the present disclosure includes content-based filtering, which is generally indicated at reference number 600. Content-based filtering 600, focuses primarily on product similarity. Content-based filtering analyzes product descriptions and identifies key features to match against the user's/customer's requirements. For example, content-based filtering 600 considers product characteristics such as, but not limited to, price, category, and user/customer preferences interpreted from their purchases and related feedback. In the example of FIG. 6, when a user/customer 602 reads an article 604, content-based filtering 600 is employed to recommend a similar article 606.

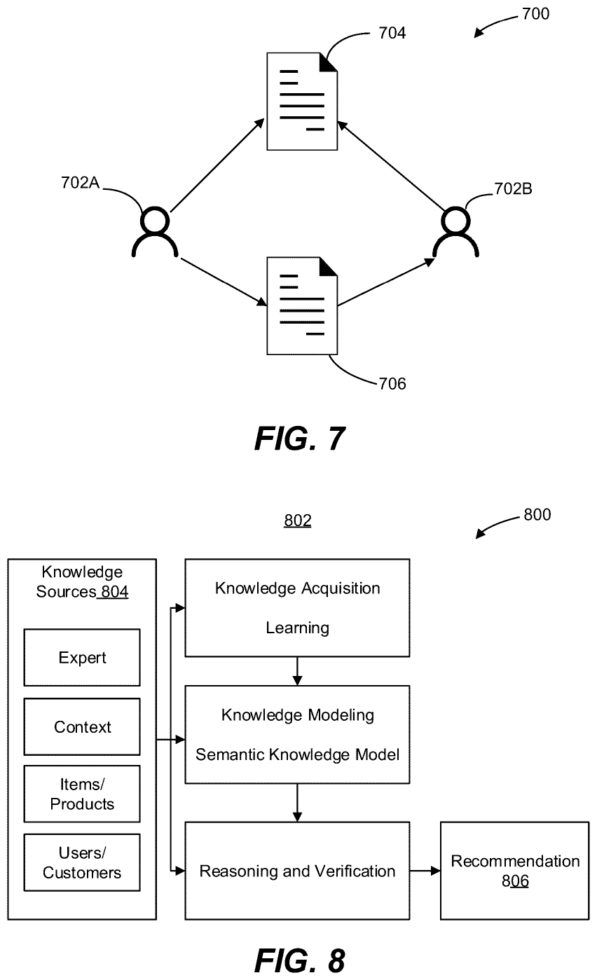

Referring now to FIG. 7, another example of a product recommendation process in accordance with the present disclosure includes collaborative filtering, which is generally indicated at reference number 700. Collaborative filtering 700 emulates having a buddy who knows you well and recommends products based on what you both like. Accordingly, collaborative filtering 700 groups customers with similar purchase patterns into clusters and suggests items that have been purchased by other customers with comparable tastes. In the example of FIG. 7, when users/customers 702A, 702B read the same article 704, collaborative filtering 700 groups the customers together and recommends other articles 706 read by the customers 702A, 702B to one another.

Another example of a product recommendation process in accordance with the present disclosure includes knowledge-based filtering. Knowledge-based filtering recommendation is based at least on explicit knowledge about the products, users/customers, and context. This is applicable in scenarios where alternative approaches such as collaborative filtering and content-based filtering cannot be applied. A major strength of knowledge-based filtering is the non-existence of cold start problems and complex domains where products are not purchased very often. A corresponding drawback is a potential knowledge acquisition and domain knowledge. In the illustrative example of FIG. 8 knowledge-based filtering 800 considers input data 802 such as knowledge acquisition, knowledge modeling, and reasoning and verification retrieved from knowledge sources 804 to make a product recommendation 806.

Natural language processing (NLP) is another product recommendation process that may be used to make a recommendation. For example, NLP may be used to analyze text reviews. Moreover, an NLP similarity search may be conducted to compare and match product descriptions based on semantic similarity, enhancing the precision of the recommendations.

As mentioned above the inference module 318 is configured to evaluate at least one of the customer data, product data, or transaction data to determine two or more product recommendation processes. In one embodiment, the inference module 318 determines whether a customer is a new customer or a returning customer based on at least one of the customer data or transaction data to determine the two or more product recommendation processes. For example, the inference module 318 executes community-based filtering and popularity-based filtering if the customer is a new customer, and community-based filtering, popularity-based filtering, and content-based filtering if the customer is a returning customer.

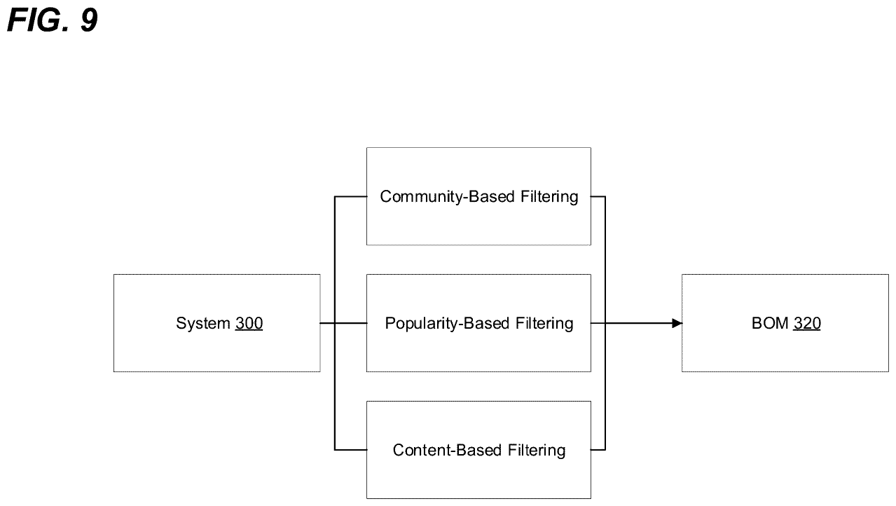

Referring now to FIG. 9, the system 300 is shown executing a hybrid approach comprising multiple different product recommendation processes to create the customer-specific BOM 320. In the illustrated embodiment, the system 300 is configured to execute community-based filtering, popularity-based filtering, and content-based filtering. The system 300 is also configured to use AI-driven NLP (not shown). However, the system 300 may be configured to execute other recommendation techniques without departing from the scope of the present disclosure. The system 300 utilizes community-based filtering to identify the most relevant quotations from transaction data, and uses popularity-based filtering suggestions for the same segments to create a hybrid approach that solves the problem. If the customer or the account for which a quotation will be generated already exists, and there are several historical transactions, the system 300 is also configured to execute content-based filtering. By using a hybrid approach, the system 300 overcomes the limitations of individual product recommendation processes and provides more accurate and relevant product recommendations.

In general, the inference module 318 executes a hybrid method to output the customer-specific BOM 320. In one embodiment, the hybrid method causes the inference module 318 to select the most similar historical quotations first. For example:
Content-Based Filtering: In this case the similar content is checked within the same account and the products are selected from the latest 2-3 quotations.
Community-Based Filtering: Apart from the same account the similar content is checked in different accounts and the community is found and the most similar 2-3 quotations are picked to get the relevant products.
Popularity-Based Filtering: Finally, the most popular products are captured from similar quotations but not selected in above two methods.

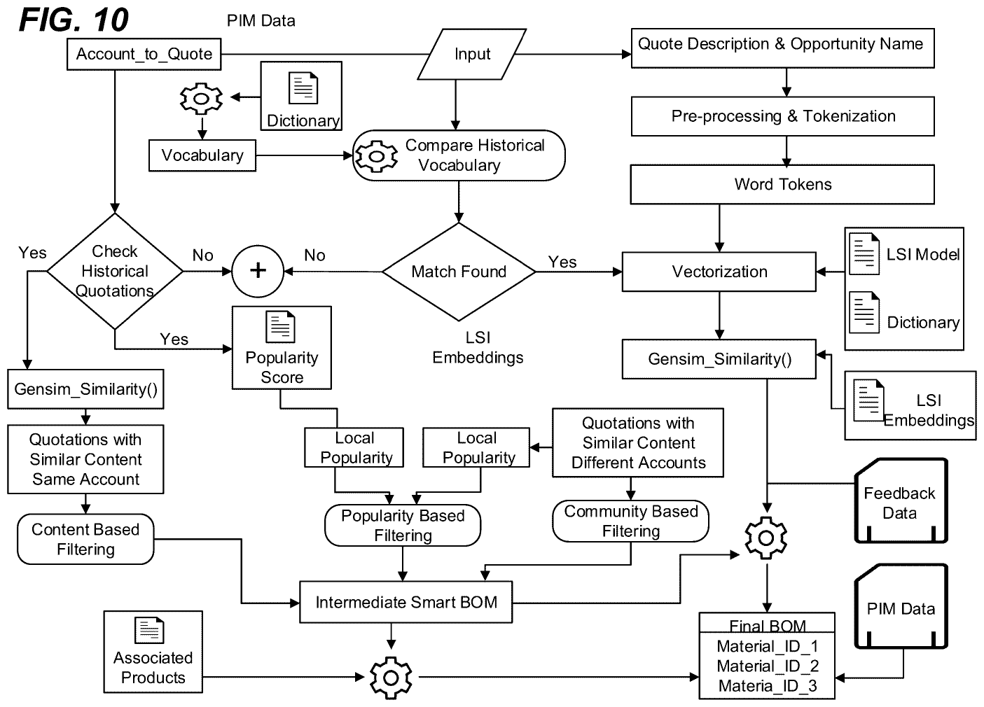

Finally, a unique combination of products is created based on the above three methods, and the customer-specific BOM 320 is produced. FIG. 10 provides an example flowchart illustrating processes of the recommendation engine 310.

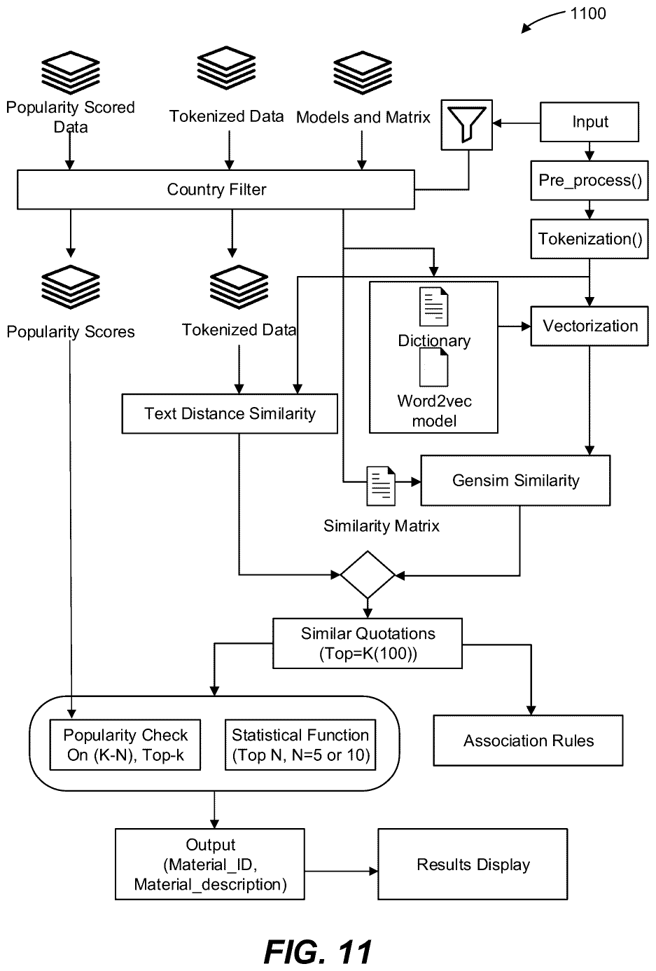

Referring now to FIG. 11 an exemplary implementation of the inference module 318 is generally indicated at reference number 1100. In this implementation the data from the training module 316 (e.g., the popularity scored data, tokenized data, and models and matrix data) is processed.

In one embodiment, the recommendation engine 310 and software modules associated therewith, are AI-driven.

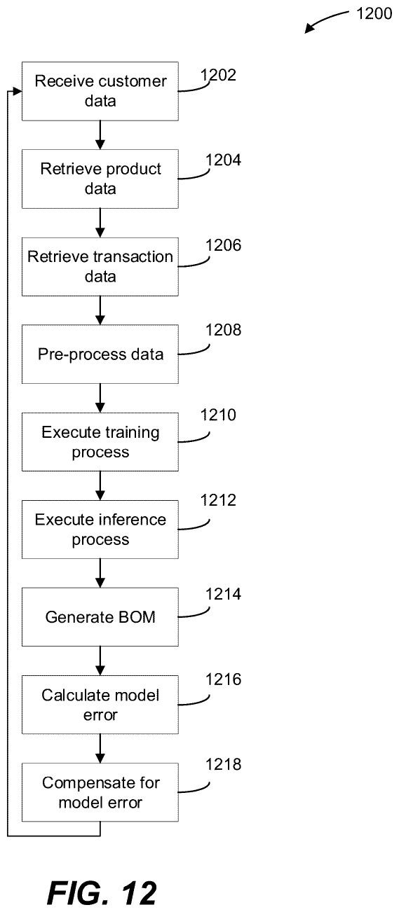

Referring to FIG. 12, an exemplary method of using the system 300 to generate a BOM is generally indicated at reference number 1200. Beginning at steps 1202, 1204, and 1206, input data for generating the BOM is retrieved. The input data includes customer data received from a user input, product data retrieved from a product data source, and transaction data retrieved from a transaction data source. Next, the input data is pre-processed into a program-compatible format at step 1208. For example, a named entity recognition (NER) tagging and removal process, a text case conversion process, an unwanted symbol removal process, a white space normalization process, and/or a stop word removal process are executed to pre-process the input data.

From here the pre-processed program-compatible data is processed. At step 1210, one or more training processes are executed with the pre-processed program-compatible data (step 1210). For example, least one of a vocabulary creation process, a popularity score generation process, an embeddings generation process, or an associated itemset generation process are executed. Next at step 1212, an inference process is executed, wherein the input data is evaluated to determine two or more product recommendation processes for determining one or more products for generating the BOM that aligns with the customer product requirements specified by the customer data. Also, during the inference process the product recommendation processes are executed based on the input data, and the BOM is generated in a machine-readable format (step 1214).

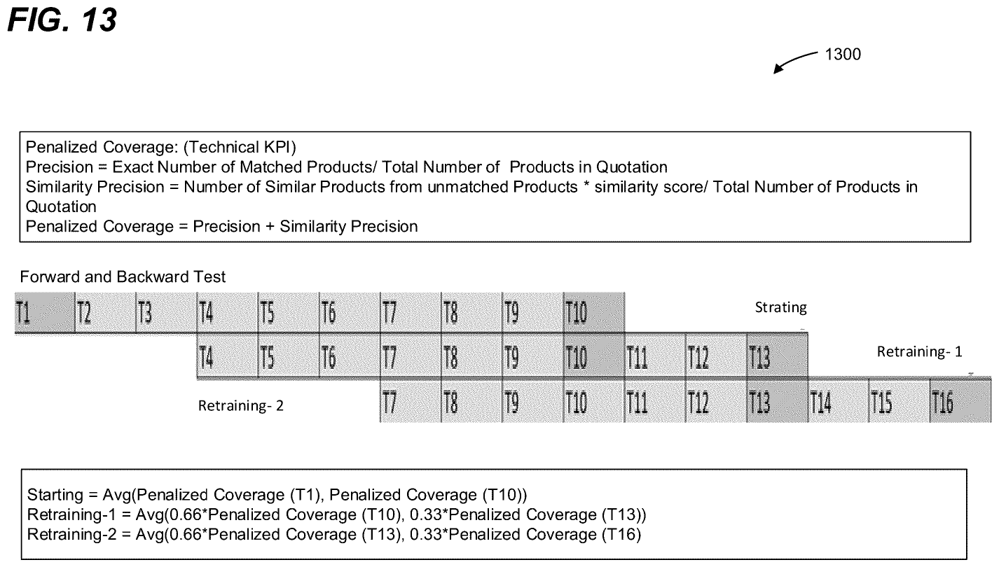

At step 1216, a model error is calculated, and compensated for at step 1218. FIG. 13 illustrates an example of a model error calculation and compensation process 1300. However, it will be apparent to a person of ordinary skill in the art that other model correction processes may be implemented without departing from the scope of the present disclosure. In the example, calculating a model error involves executing a precision calculation process wherein a number of product recommendations of the bill of materials that align with the customer product requirements is determined. Moreover, a similarity precision calculation process wherein a similarity of unmatched product recommendations of the bill of materials to products purchased by a customer is determined, is executed. In the example, compensating for the model error involves executing a penalizing process based at least on results from the precision calculation process and the similarity precision calculation process. In one embodiment, steps 1214 and 1216 occur at predefined intervals. But steps 1214 and 1216 may also occur randomly. Finally, from here the method may be re-executed to generate a new machine-readable BOM that compensates for the model error.

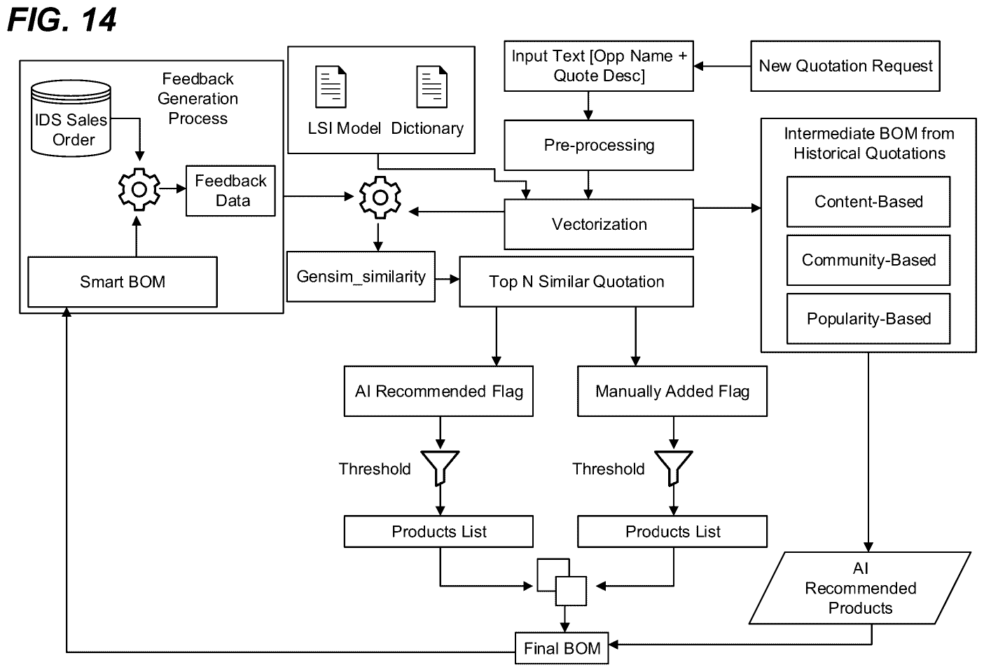

The system 300 incorporates a machine learning (ML) pipeline to enable continuous integration and continuous delivery (CI/CD) capabilities for the ML development lifecycle, and to automate the training, updating, and release of model versions. In the exemplary embodiment of FIG. 14, the AWS Step Function Data Science SDK is used to achieve this. From training to inference, there is a provision to refresh the model as well on predefined intervals. The AWS Step Functions is divided into three main stages: in the first stage, historical data is extracted from an IDS by querying a data lake. The extracted data that contains the corpus of items is grouped into an Amazon S3 bucket, after transforming it into a format that can be consumed by the training algorithm. In the next stage, SageMaker is used to train a Doc2vec model on the saved corpus of items using a distributed cluster of multiple CPU instances. In the last stage, a SageMaker endpoint is configured and deployed, serving the Doc2vec-NN recommendations. When an inference request comes in, the embedding for the word is generated, top K nearest items are calculated, and the list is returned back to the user in the response. An Amazon API Gateway layer is used in conjunction with an AWS Lambda function to handle the HTTPS requests from the front-end application to the SageMaker inference endpoint. This workflow is automatically triggered periodically to keep the model up to date with the new data and new items. Amazon Event Bridge is used to trigger the Step Functions workflow every 90 days to retrain the model with new data and to deploy a new version of the model. For training and inference, SageMaker SkLearn container provided by the AI Technology team is used. The training pipeline will register the model into SageMaker Model registry in the appropriate model group. SageMaker inference workflow will take latest approved model from the model group and deploy it to an endpoint. Training will push the preprocessed data or pack them into the same artifact along with the models, so that those can be used in inference.

The solution architecture is implemented. Instead of step functions for orchestrating the steps in pipeline, Glue Job Scheduler is used for scheduling a data ingestion framework. Two files will be generated QuoteMaterial (23 columns) and QuoteOpportunity (52 columns) and placed inside the processed folder inside the S3. Each file comprises a data size close to 400 mb. The model training pipeline is called using AWS Lambda. Model retraining will only happen after the latest data present in the S3 for file size, number of records, matched common QuoteID/QuoteNumber is configurable. All countries model artifact are zipped as a single zipped file and registered as a single.model.tar.gz into the SageMaker model registry. A specific country model will be called based on inputs received from the CPQ system. All the models will be hosted in a single instance of higher capacity starting with 56 GB Ram.

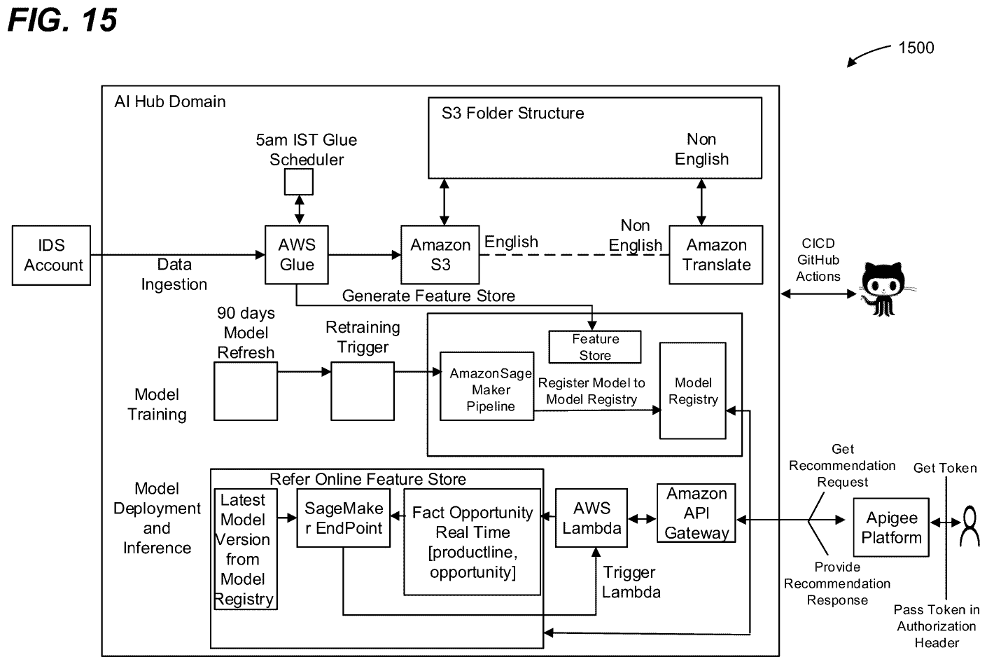

An example machine training and inference architecture for generating a smart BOM is generally indicated at reference number 1500 in FIG. 15.

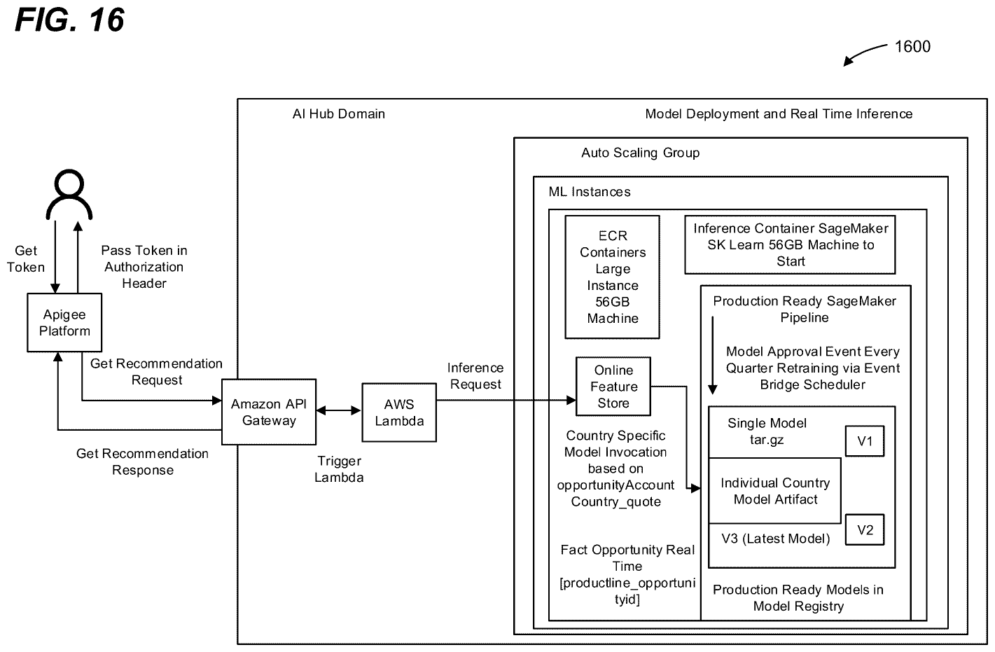

An example inference architecture for generating a smart BOM is generally indicated at reference number 1600 in FIG. 16.

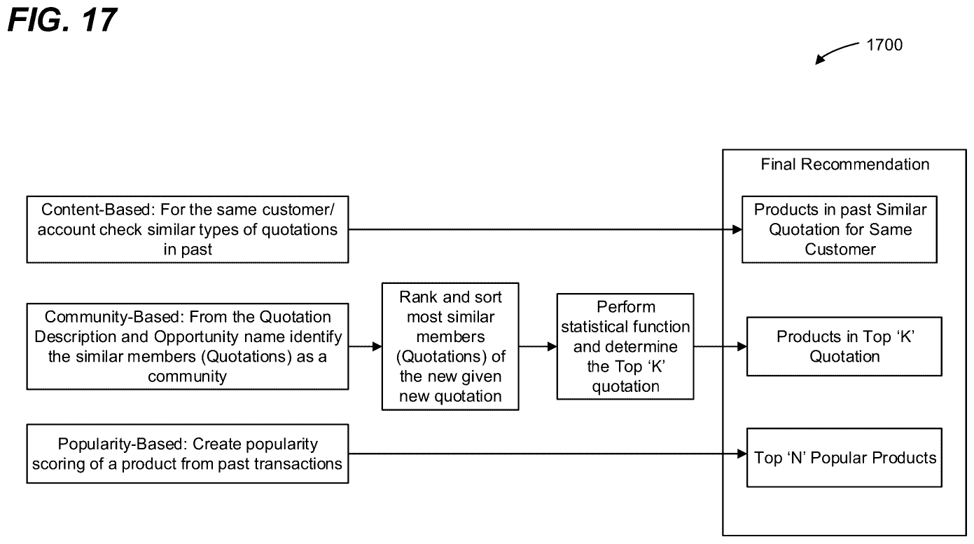

An example processes for generating a smart BOM is generally indicated at reference number 1700 in FIG. 17. In this example, content-based, community-based, and popularity-based filtering are used for generating the smart BOM. For the content-based filtering, customer data is evaluated to determine similar types of quotations in the past. Products in a past similar quote are included in a final recommendation to the customer. For the community-based filtering, similar members (e.g., quotations) are identified as a community from a quotation description and opportunity name. Next the most similar members of the community are ranked and sorted. A statistical function is performed to determine the top ‘K’ quotation for the final recommendation. For the popularity-based filtering, popularity scoring of products from past transactions are created, and the top ‘N’ products are included in the final recommendation.

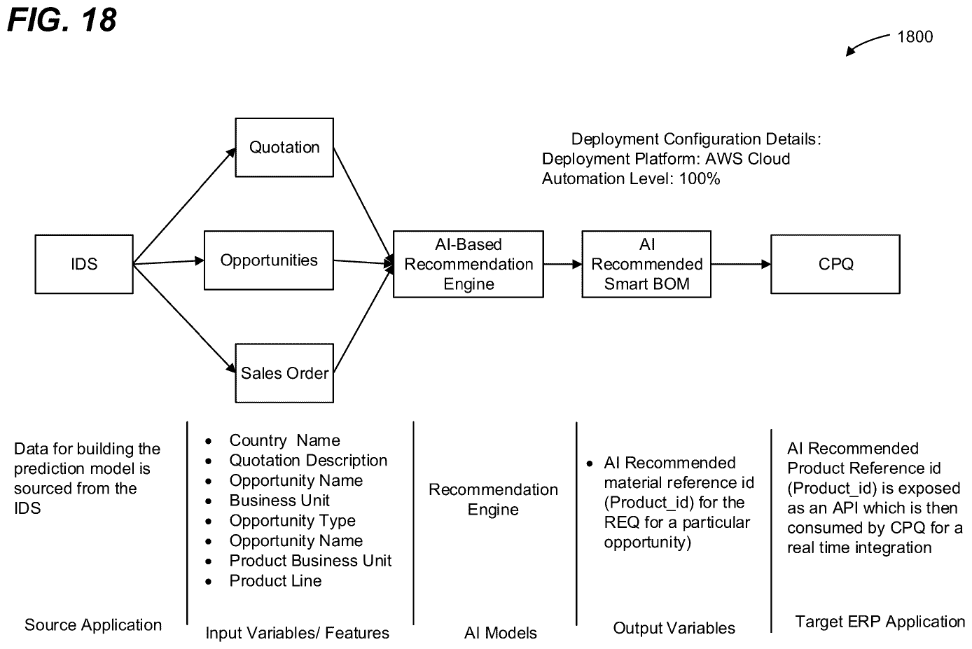

A high-level implementation of a system in accordance with the present disclosure is generally indicated at reference number 1800 in FIG. 18. Data for building a prediction model is sourced from an IDS. Exemplary input variables and features for the prediction model include, but are not limited to: country name, quotation description, opportunity name, business unit, opportunity type, opportunity name, product business unit, and product line. An exemplary output includes an AI-recommended product ID for the request for a particular opportunity. This is then exposed to an Application Programming Interface (API) and consumed by a Configure Price Quote (CPQ) for a real-time integration.

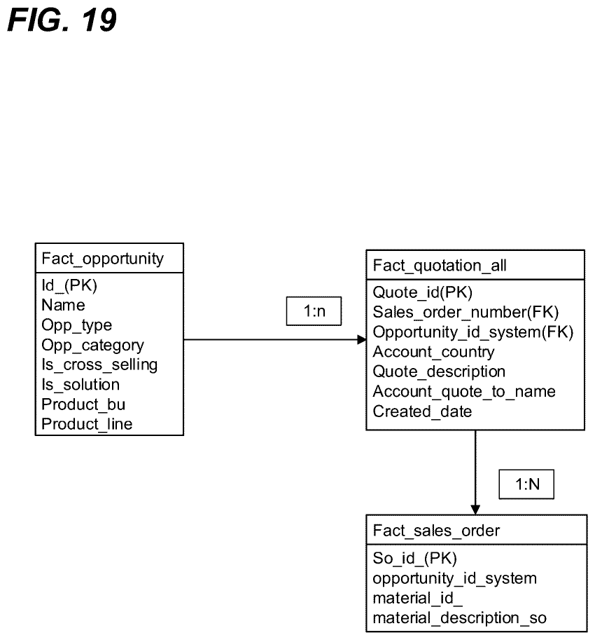

FIG. 19 illustrates an example of input data and corresponding relationships that may be used with the present disclosure.

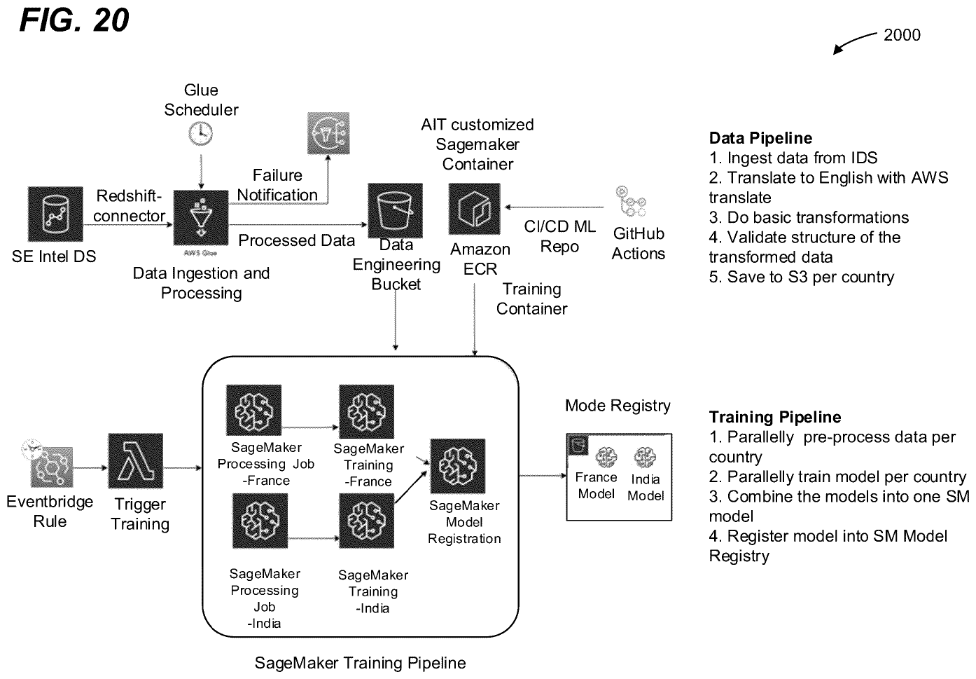

FIG. 20 illustrates an example of a data and training pipeline 2000 in accordance with the present disclosure. With the data pipeline, data is ingested from an IDS and translated to English with AWS translate. Basic data transformations are performed, the structured of the transformed data is validated, and saved to an S3 per country. For the training pipeline, data is pre-processed per country. The model is trained per country. The models are then combined into one SM model, and the model is registered into an SM model registry.

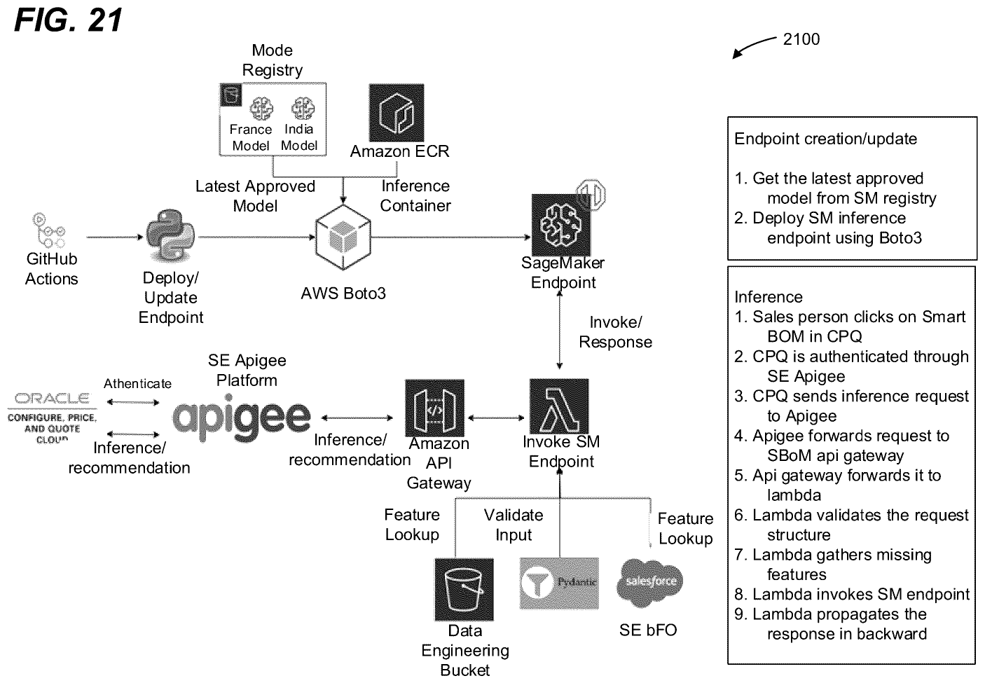

FIG. 21 illustrates an example of an inference pipeline 2100 in accordance with the present disclosure. An endpoint creation/update involves getting the latest approved model from the SM model registry, and deploying the SM inference endpoint using Boto3. Inference involves a sales person clicking on Smart BOM in CPQ. The CPQ is authenticated through Schneider Electric's Apigee platform. The CPQ sends an inference request to Apigee. Apigee forwards the request to Smart BOM's API gateway. The API gateway forwards it to lambda. Lambda validates the request structure. Lambda gathers missing features. Lambda invokes SM endpoint. Lambda propagates the response in backward.

The system of the present disclosure comprises an AI-driven solution that analyzes input data such as customer and historical data to make proactive bill of material (BOM) recommendations. Furthermore, the system is configured to simplify sales processes, reduce administrative tasks, and ultimately improve customer satisfaction. By recommending associated products and reducing the number of revisions in the quotation process, the system is configured to aid company sales teams to meet customer expectations and streamline their workflow. The system utilizes a method of selecting relevant products based on historical quotation and opportunity data, making it faster and easier than conventional product recommendation systems.

The system of the present disclosure comprises distributed data processing for handling large amounts of data. Moreover, the system is configured to cost-effectively keep machine-learning models up to date with incremental historical data ingestion and updates. Additionally, the same may be utilized for different languages, as the system has AWS translation capabilities.

Advantageously, systems and methods of the present disclosure automatically provide a fine-tuned recommended bill of materials that includes more precise product suggestion. Furthermore, the systems and methods enable users to easily switch a context of a search when determining relevant products. In other words, the present disclosure provides a fine-tune search and context-switching of the recommended bill of materials. The dynamic context switching of recommendations and the ability to fine-tune them as required, offer users a more personalized and responsive experience, aligning with the evolving nature of user preferences and needs. For example, from the payload an extra text field will be present, and a user can send the relevant information, i.e. a more contextual quote requirement. This will fine-tune the recommendation and provide a more precise product suggestion, and a user can switch the context of the search as well.

Current recommendation systems are mostly generalized and suggest different types of products than what is actually needed. The present disclosure provides contextual filtering of relevant product types to help reduce unwanted product groups from interfering with the recommended BOM. For example, the system of the present disclosure is configured to search for exact products or similar products based on partial product definition. The absence of rating data to establish user-product relationships necessitates a hybrid approach using content-based, community-based, and popularity-based filtering, showcasing an innovative adaptation to overcome data limitations. The implementation of explicit feedback without the need for retraining to accommodate the impact of human feedback represents a departure from traditional batch-oriented retraining processes.

Overall, the incorporation of these features and approaches reflects a forward-looking and adaptive approach to recommendation systems, leveraging AI to provide more contextually relevant and personalized product suggestions.

Embodiments of the present disclosure comprise a special purpose computer including a variety of computer hardware, as described in greater detail herein and are operational with other special purpose computing system environments or configurations even if described in connection with an example computing system environment. The computing system environment is not intended to suggest any limitation as to the scope of use or functionality of any aspect of the present disclosure. Moreover, the computing system environment should not be interpreted as having any dependency or requirement relating to any one or combination of components illustrated in the example operating environment. Examples of computing systems, environments, and/or configurations that may be suitable for use with aspects of the present disclosure include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Aspects of the present disclosure may be described in the general context of data and/or processor-executable instructions, such as program modules, stored one or more tangible, non-transitory storage media and executed by one or more processors or other devices. Generally, program modules include, but are not limited to, routines, programs, objects, components, and data structures that perform particular tasks or implement particular abstract data types. Aspects of the present disclosure may also be practiced in distributed computing environments where tasks are performed by remote processing devices that are linked through a communications network. In a distributed computing environment, program modules may be located in both local and remote storage media including memory storage devices. For purposes of illustration, programs and other executable program components may be shown as discrete blocks. It is recognized, however, that such programs and components reside at various times in different storage components of a computing device, and are executed by a data processor(s) of the device.

In operation, processors, computers, and/or servers may execute the processor-executable instructions (e.g., software, firmware, and/or hardware) such as those illustrated herein to implement aspects of the present disclosure. The processor-executable instructions may be organized into one or more processor-executable components or modules on a tangible processor readable storage medium. Also, embodiments may be implemented with any number and organization of such components or modules. For example, aspects of the present disclosure are not limited to the specific processor-executable instructions or the specific components or modules illustrated in the figures and described herein. Other embodiments may include different processor-executable instructions or components having more or less functionality than illustrated and described herein.

The order of execution or performance of the operations in accordance with aspects of the present disclosure illustrated and described herein is not essential, unless otherwise specified. That is, the operations may be performed in any order, unless otherwise specified, and embodiments may include additional or fewer operations than those disclosed herein. For example, it is contemplated that executing or performing a particular operation before, contemporaneously with, or after another operation is within the scope of the present disclosure.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided, and components may be combined. Alternatively, or in addition, a component may be implemented by several components.

Having described the present disclosure in detail, it will be apparent that modifications and variations are possible without departing from the scope of the present disclosure defined in the appended claims.

When introducing elements of the present disclosure or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several aspects of the present disclosure are achieved and other advantageous results attained.

As various changes could be made in the above products without departing from the scope of the present disclosure, it is intended that all matter contained in the above description and shown in the accompanying drawings shall be interpreted as illustrative and not in a limiting sense.

The Abstract and Summary are provided to help the reader quickly ascertain the nature of the technical disclosure. They are submitted with the understanding that they will not be used to interpret or limit the scope or meaning of the claims. The Summary is provided to introduce a selection of concepts in simplified form that are further described in the Detailed Description. The Summary is not intended to identify key features or essential features of the claimed subject matter, nor is it intended to be used as an aid in determining the claimed subject matter.

1. A system comprising:
a bill of materials (BOM) processing device, the BOM processing device in operable communication with a product data source and a transaction data source, the product data source storing product data associated with a company's product portfolio, the transaction data source storing transaction data associated with the company's transactions;
a memory device in operable communication with the BOM processing device and storing processor-executable instructions defining a recommendation engine that, when executed, configures the BOM processing device for:
receiving, via a user input, customer data representative of customer information and customer product requirements;
retrieving product data from the product data source based on the customer data;
retrieving transaction data from the transaction data source based on the customer data;
evaluating at least one of the customer data, product data, or transaction data to determine two or more product recommendation processes for determining one or more products for generating a bill of materials that aligns with the customer product requirements; and
executing the product recommendation processes based at least on the customer data, product data, or transaction data to generate the bill of materials in a machine-readable format.

2. The system of claim 1, wherein the recommendation engine, when executed, further configures the BOM processing device for pre-processing at least one of the customer data, product data, or transaction data to convert the data into a program-compatible format.

3. The system of claim 2, wherein said pre-processing comprises at least one of a named entity recognition tagging and removal process, a text case conversion process, an unwanted symbol removal process, a white space normalization process, or a stop word removal process.

4. The system of claim 1, wherein the recommendation engine, when executed further configures the BOM processing device for executing one or more training processes based at least on the customer data, product data, and transaction data, and wherein said training processes comprise at least one of a vocabulary creation process, a popularity score generation process, an embeddings generation process, or an associated itemset generation process.

5. The system of claim 4, wherein said training processes are executed using at least one of an FP Growth Tree algorithm or an Apriority algorithm.

6. The system of claim 1, wherein said executing the two or more product recommendation processes comprises executing two or more of content-based filtering, community-based filtering, or popularity-based filtering.

7. The system of claim 6, wherein said evaluating comprises determining whether a customer is a new customer or a returning customer based on at least one of the customer data or transaction data to determine the two or more product recommendation processes.

8. The system of claim 7, wherein community-based filtering and popularity-based filtering are executed if the customer is a new customer, and wherein community-based filtering, popularity-based filtering, and content-based filtering are executed if the customer is a returning customer.

9. The system of claim 1, wherein the recommendation engine comprises an artificial intelligence engine.

10. The system of claim 1, wherein the recommendation engine, when executed further configures the BOM processing device for transmitting the machine-readable bill of materials to a quote development system.

11. A system comprising:
a bill of materials (BOM) processing device, the BOM processing device in operable communication with a product data source and a transaction data source, the product data source storing product data associated with a company's product portfolio, the transaction data source storing transaction data associated with the company's transactions;
a memory device in operable communication with the BOM processing device and storing processor-executable instructions defining a recommendation engine that, when executed, configures the BOM processing device for:
receiving, via a user input, customer data representative of customer information and customer product requirements;
retrieving product data from the product data source based on the customer data;
retrieving transaction data from the transaction data source based on the customer data; and
executing one or more training processes based at least on the customer data, product data, or transaction data, wherein said training processes comprise at least one of a vocabulary creation process, a popularity score generation process, an embeddings generation process, or an associated itemset generation process.

12. The system of claim 11, wherein said training processes are executed using at least one of an FP Growth Tree algorithm or an Apriority algorithm.

13. The system of claim 11, wherein the recommendation engine, when executed further configures the BOM processing device for pre-processing at least one of the customer data, product data, or transaction data to convert the data into a program-compatible format.

14. The system of claim 13, wherein said pre-processing comprises at least one of a named entity recognition tagging and removal process, a text case conversion process, an unwanted symbol removal process, a white space normalization process, or a stop word removal process.

15. The system of claim 11, wherein the recommendation engine comprises an artificial intelligence engine.

16. A computer-implemented method comprising:
receiving, via a user input, customer data representative of customer information and customer product requirements;
retrieving product data associated with a company's product portfolio from a product data source based on the customer data;
retrieving transaction data associated with the company's transactions from a transaction data source based on the customer data; and
processing the customer data, product data, and transaction data to generate a machine-readable bill of materials, the machine-readable bill of materials comprising one or more product recommendations that align with the customer product requirements;
calculating a model error; and
compensating for the model error; and
re-executing the method to generate a new machine-readable bill of materials that compensates for the model error.

17. The computer-implemented method of claim 16, wherein said calculating the model error comprises executing a precision calculation process wherein a number of product recommendations of the bill of materials that align with the customer product requirements is determined.

18. The computer-implemented method of claim 17, wherein said calculating the model error further comprises executing a similarity precision calculation process wherein a similarity of unmatched product recommendations of the bill of materials to products purchased by a customer is determined.

19. The computer-implemented method of claim 18, wherein said compensating for the model error comprises executing a penalizing process based at least on results from the precision calculation process and the similarity precision calculation process.

20. The computer-implemented method of claim 16, wherein said calculating the model error and compensating for the model error occurs at predefined intervals.
